(19) United States
(12) Patent Application Publication
(10) Pub. No.: US 2026/0135261 A1
(43) Pub. Date: May 14, 2026

(54) ENERGY STORAGE APPARATUS

(71) Applicant: GS Yuasa International Ltd., Kyoto-shi (JP)

(72) Inventor: Masayoshi OGUSHI, Kyoto-shi (JP)

(21) Appl. No.: 19/444,362

(22) Filed: Jan. 9, 2026

Related U.S. Application Data
(63) Continuation of application No. PCT/JP2024/025401, filed on Jul. 16, 2024.

(30) Foreign Application Priority Data
Jul. 20, 2023 (JP) 2023-118030

(51) Int. Cl. H01M 50/503; H01G 11/10; H01M 50/209; H01M 50/289

(52) U.S. Cl. CPC H01M 50/503; H01M 50/209; H01M 50/289; H01G 11/10

(57) ABSTRACT

An energy storage apparatus includes a first energy storage device, a spacer, a bus bar, and a bus bar holder. The first energy storage device and the spacer are arranged side by side in a first direction. The first energy storage device includes a first terminal arranged in a second direction intersecting the first direction. The bus bar is joined to the first terminal. The spacer includes a first facing portion. The bus bar holder includes a second facing portion facing the first facing portion in the first direction. The second facing portion is between the first facing portion and a portion of the bus bar in the first direction.

### CROSS REFERENCE TO RELATED APPLICATIONS

This application claims the benefit of priority to Japanese Patent Application No. 2023-118030 filed on Jul. 20, 2023 and is a Continuation Application of PCT Application No. PCT/JP 2024/025401 filed on Jul. 16, 2024. The entire contents of each application are hereby incorporated herein by reference.

### BACKGROUND OF THE INVENTION

### 1. Field of the Invention

The present invention relates to energy storage apparatuses.

### 2. Description of the Related Art

JP-A-2021-086794 discloses a power supply device including a battery assembly composed of a plurality of battery cells and a bus bar module, and the bus bar module includes a case assembled to the battery assembly and bus bars supported by the case and electrically connected to electrodes of the battery cells of the battery assembly. The case is integrally formed of, for example, an electrically insulating synthetic resin or the like, and includes a plurality of bus bar accommodating portions. The bus bar accommodating portions are arranged in two rows along an arrangement direction of the plurality of battery cells. The bus bar accommodating portion is formed in a frame shape, and the bus bar is accommodated in the bus bar accommodating portion.

### SUMMARY OF THE INVENTION

In the above conventional bus bar module, each of the plurality of bus bars is accommodated in the bus bar accommodating portion of the case. The bus bar accommodating portion is formed to support the bus bar and surround the bus bar in plan view. By disposing the bus bar module configured as described above with respect to the battery assembly, the plurality of bus bars can be arranged with respect to the plurality of battery cells. However, in this case, it may be difficult to accurately align the position of the bus bar with the position of the electrode of the battery cell in consideration of positional deviation or the like of the bus bar in the bus bar accommodating portion. As a result, there is a possibility that the bus bar and the electrode of the battery cell cannot be favorably joined.

Example embodiments of the present invention provide energy storage apparatuses each with improved reliability.

An energy storage apparatus according to an example embodiment of the present invention includes a first energy storage device, a spacer, a bus bar, and a bus bar holder, in which the first energy storage device and the spacer are arranged side by side in a first direction, the first energy storage device includes a first terminal arranged in a second direction intersecting the first direction, the bus bar is joined to the first terminal, the spacer includes a first facing portion, the bus bar holder includes a second facing portion facing the first facing portion in the first direction, and the second facing portion is between the first facing portion and a portion of the bus bar in the first direction.

According to example embodiments of the present invention, it is possible to provide energy storage apparatuses each with improved reliability.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating a configuration of an energy storage apparatus according to an example embodiment of the present invention.

FIG. 2 is an exploded perspective view of a bus bar assembly according to an example embodiment of the present invention.

FIG. 3 is a perspective view of a bus bar, a spacer, and two energy storage devices according to an example embodiment of the present invention.

FIG. 4 is an enlarged perspective view illustrating a configuration of the bus bar and its periphery according to an example embodiment of the present invention.

FIG. 5 is a perspective view illustrating a configuration of a bus bar accommodating portion according to an example embodiment of the present invention.

FIG. 6 is a plan view illustrating a positional relationship among a first facing portion, a second facing portion, and the bus bar according to an example embodiment of the present invention.

FIG. 7 is a cross-sectional view illustrating the positional relationship among the first facing portion, the second facing portion, and the bus bar according to an example embodiment of the present invention.

### DETAILED DESCRIPTION OF THE EXAMPLE EMBODIMENTS

An energy storage apparatus according to an example embodiment of the present invention includes a first energy storage device, a spacer, a bus bar, and a bus bar holder, in which the first energy storage device and the spacer are arranged side by side in a first direction, the first energy storage device includes a first terminal arranged in a second direction intersecting the first direction, the bus bar is joined to the first terminal, the spacer includes a first facing portion, the bus bar holder includes a second facing portion facing the first facing portion in the first direction, and the second facing portion is between the first facing portion and a portion of the bus bar in the first direction.

According to the energy storage apparatus described in (1), in the arranging direction (first direction) of the first energy storage device and the spacer, the first facing portion of the spacer faces the second facing portion of the bus bar holder, and the second facing portion is between the first facing portion and a portion of the bus bar. Therefore, the first facing portion of the spacer can restrict the movement of the bus bar in the first direction via the second facing portion. Accordingly, the first facing portion of the spacer can guide the bus bar to a position suitable for joining the bus bar and the first terminal. As a result, the bus bar can be accurately joined to the first terminal. As described above, the energy storage apparatus according to the aspect is an energy storage apparatus with improved reliability.

(2) In the energy storage apparatus described in (1), the first facing portion may be in contact with the second facing portion in the first direction, and an end of the second facing portion on one side in one direction intersecting the first direction may be fixed and an end of the second facing portion on the other side in the one direction may not be fixed in the bus bar holder.

According to the energy storage apparatus described in (2), the second facing portion is brought into contact with the first facing portion in the first direction, so that the second facing portion can be efficiently displaced or deformed in a direction toward the portion of the bus bar. As a result, the second facing portion can efficiently guide the bus bar to an appropriate position.

(3) In the energy storage apparatus described in (2), the bus bar holder may include an intermediate wall portion positioned between the first facing portion and the portion of the bus bar in the first direction, and the second facing portion may be a portion of the intermediate wall portion.

According to the energy storage apparatus described in (3), since the second facing portion is provided as a portion of the intermediate wall portion, the mechanical strength of the second facing portion is improved.

(4) The energy storage apparatus described in any one of (1) to (3) may further include a second energy storage device, the second energy storage device may include a second terminal arranged in the second direction, the spacer may be positioned between the first energy storage device and the second energy storage device in the first direction, and the bus bar may be joined to the first terminal and the second terminal.

According to the energy storage apparatus described in (4), the bus bar for connecting the two energy storage devices adjacent to each other in the first direction with the spacer interposed therebetween is restricted in movement by the first facing portion of the spacer. Thus, the bus bar is provided at a position suitable to join the bus bar to the terminals of the two energy storage devices.

(5) In the energy storage apparatus described in any one of (1) to (4), the first facing portion may be arranged side by side with the first terminal in the first direction.

According to the energy storage apparatus described in (5), the first facing portion is arranged in a range of a width of the first terminal in a direction (third direction) intersecting the first direction and the second direction. Accordingly, the bus bar holder can be provided with the second facing portion without increasing the width of the bus bar holder in the third direction.

(6) In the energy storage apparatus described in any one of (1) to (5), the second facing portion may include a convex portion projecting toward the portion of the bus bar, and the bus bar may include a recessed portion into which at least a portion of the convex portion is inserted.

According to the energy storage apparatus described in (6), at least the portion of the convex portion of the second facing portion is inserted into the recessed portion of the bus bar in the first direction. Thus, movement of the bus bar in the direction (third direction) intersecting the first direction and the second direction is restricted. That is, the first facing portion can also restrict the movement of the bus bar in the third direction via the second facing portion. As a result, the bus bar is more reliably guided to an appropriate position.

Hereinafter, energy storage apparatuses according to example embodiments (including modification examples thereof) of the present invention will be described with reference to the drawings. The example embodiments described below illustrate comprehensive or specific examples. Numerical values, shapes, materials, components, arrangement positions and connection modes of the components, manufacturing processes, the order of the manufacturing processes, and the like illustrated in the following example embodiments are merely examples, and are not intended to limit the present invention. In the drawings, dimensions and the like are not strictly illustrated. In the drawings, identical or similar components are denoted by identical reference numerals.

In the following description and drawings, an arranging direction of a pair of terminals included in an energy storage device or a facing direction of a pair of short side surfaces in a container of the energy storage device is defined as an X-axis direction. A facing direction of a pair of long side surfaces in the container of the energy storage device, a thickness direction (flat direction) of the container of the energy storage device, or an arranging direction of a plurality of the energy storage devices included in an energy storage apparatus is defined as a Y-axis direction. A projecting direction of the terminal of the energy storage device, an arranging direction of a container body and a lid plate of the energy storage device, an arranging direction of the energy storage apparatus and the bus bar assembly, or a vertical direction is defined as a Z-axis direction. The X-axis direction, the Y-axis direction, and the Z-axis direction are directions intersecting (orthogonal in the present example embodiment) each other. Although the Z-axis direction may not be the vertical direction depending on the usage mode, the Z-axis direction will be described below as the vertical direction for convenience of description.

In the following description, an X-axis positive direction indicates an arrow direction of the X axis, and an X-axis negative direction indicates a direction opposite to the X-axis positive direction. Simply referring to the X-axis direction refers to either or both of the X-axis positive direction and the X-axis negative direction. One side and the other side in the X-axis direction refer to one and the other of the X-axis positive direction and the X-axis negative direction. The same applies to the Y-axis direction and the Z-axis direction. Expressions indicating relative directions or postures, such as parallel and orthogonal, may include other directions or postures in a strict sense. For example, two directions being parallel not only means that the two directions are completely parallel, but also means that the two directions are substantially parallel, that is, include a difference of, for example, about several percent. In the following description, the expression “insulation” means “electrical insulation”. An insulating material is preferably formed from a material having a volume resistivity of 1×10¹⁰ Ωm or more.

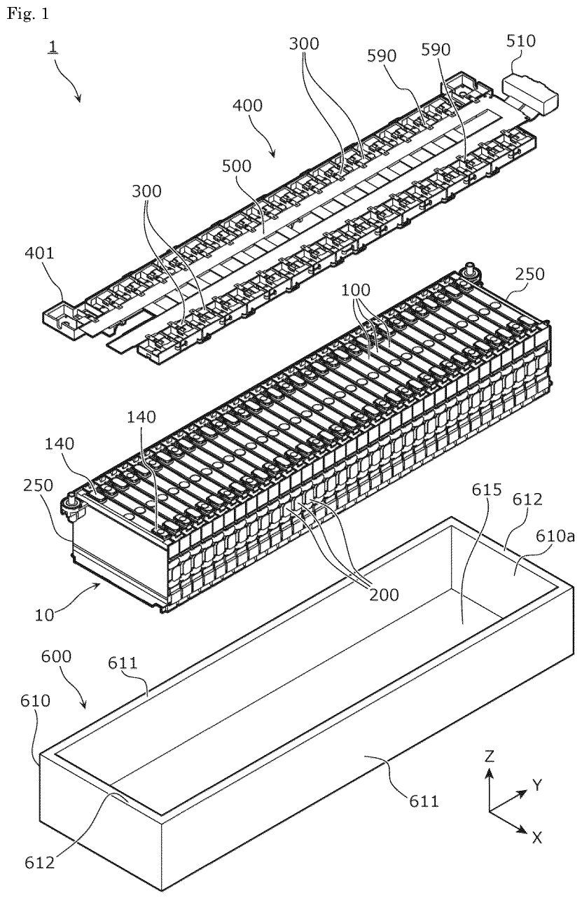

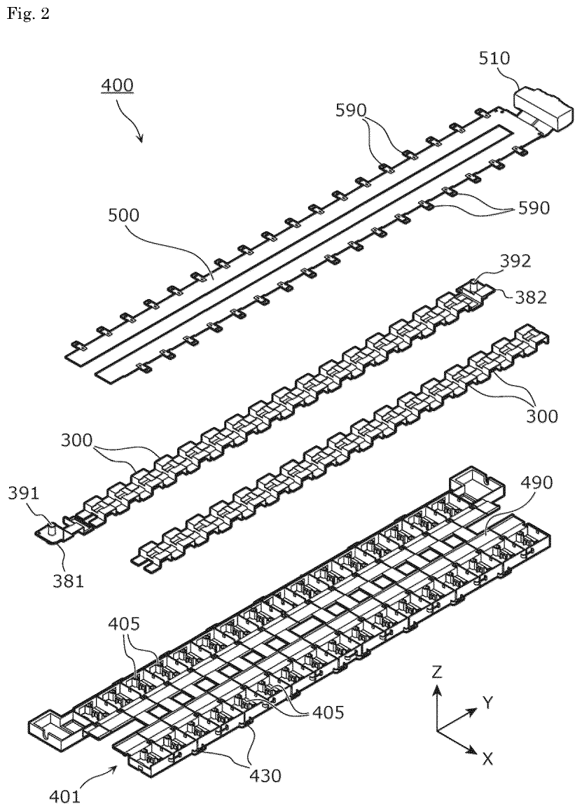

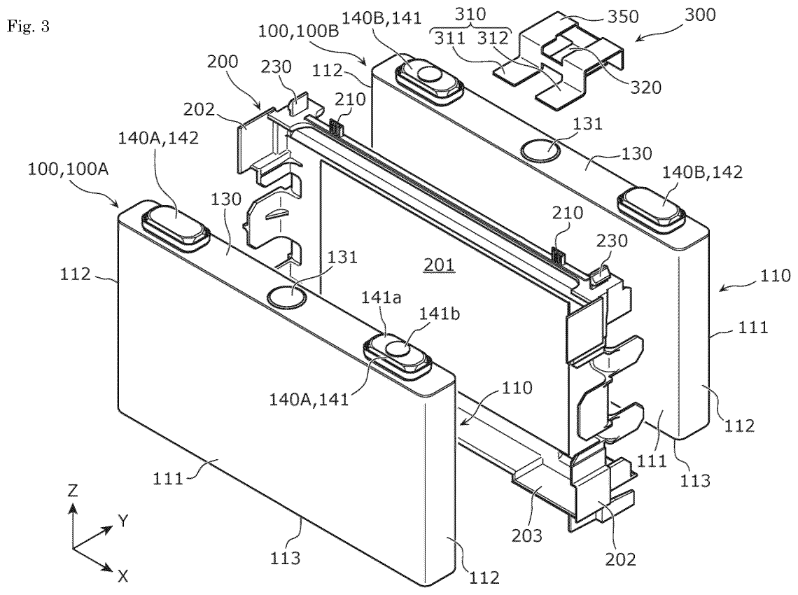

FIG. 1 is a perspective view illustrating a configuration of an energy storage apparatus 1 according to an example embodiment. FIG. 1 illustrates a state where an energy storage apparatus 10 and a bus bar assembly 400 are taken out from a case body 610. FIG. 2 is an exploded perspective view of the bus bar assembly 400 according to the present example embodiment. FIG. 3 is a perspective view of a bus bar 300, a spacer 200, and two energy storage devices 100 according to the present example embodiment. In FIG. 3, illustration of a bus bar holder 401 is omitted. The two energy storage devices 100 illustrated in FIG. 3 are two energy storage devices 100 adjacent to each other in the Y-axis direction with the spacer 200 interposed therebetween. When these two energy storage devices 100 are described in a distinguished manner, the energy storage device 100 in the Y-axis negative direction is referred to as a first energy storage device 100A, and the energy storage device 100 in the Y-axis positive direction is referred to as a second energy storage device 100B. The first energy storage device 100A and the second energy storage device 100B are two energy storage devices 100 adjacent to each other in the Y-axis direction arbitrarily selected from a plurality of energy storage devices 100 (see FIG. 1) included in the energy storage apparatus 1. The Y-axis direction is an example of a first direction.

The energy storage apparatus 1 is an apparatus that can be charged with electricity from the outside and discharge electricity to the outside. The energy storage apparatus 1 is, for example, a battery module (assembled battery) used for power storage application, power supply application, or the like. Specifically, the energy storage apparatus 1 is used as, for example, a battery for driving or starting an engine of a moving body such as an automobile, a motorcycle, a watercraft, a ship, a snowmobile, an agricultural machine, a construction machine, an automatic guided vehicle (AGV), or a railway vehicle for an electric railway. Examples of the automobile include an electric vehicle (EV), a hybrid electric vehicle (HEV), a plug-in hybrid electric vehicle (PHEV), and a fossil fuel (gasoline, light oil, liquefied natural gas, etc.) automobile. Examples of the railway vehicle for an electric railway include a train, a monorail, a linear motor car, and a hybrid train including both a diesel engine and an electric motor. In addition, the energy storage apparatus 1 can also be used as a stationary battery or the like used for home use, business use, or the like.

As illustrated in FIG. 1, the energy storage apparatus 1 includes the energy storage apparatus 10, the bus bar assembly 400, and a case 600 that accommodates the energy storage apparatus 10. In addition to the above components, the energy storage apparatus 1 may include electric equipment such as a circuit board and a relay that monitor or control a charge state, a discharge state, and the like of the energy storage apparatus 10.

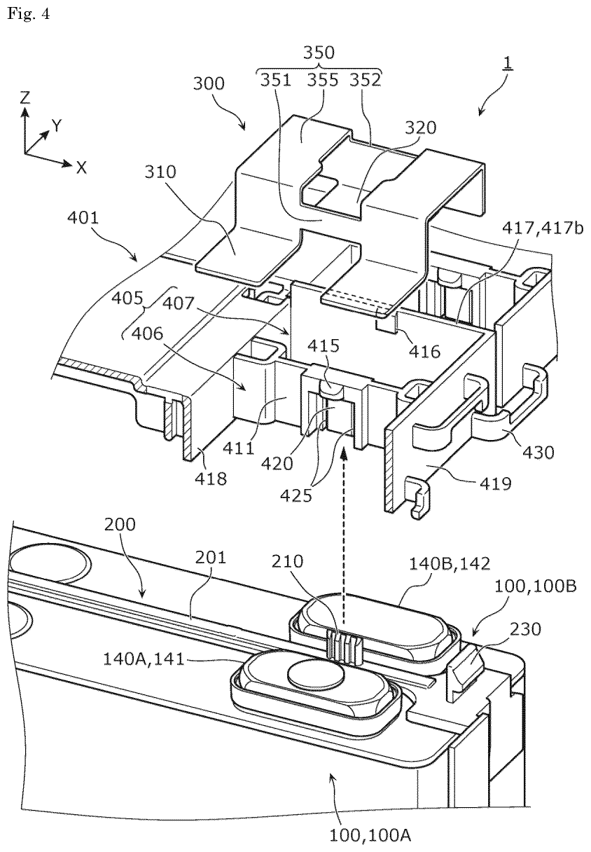

In the present example embodiment, the energy storage apparatus 10 is a battery module including one or more energy storage devices 100. Specifically, the energy storage apparatus 10 includes the plurality of (for example, thirty four in the present example embodiment) energy storage devices 100, the spacer 200 disposed between two energy storage devices 100 adjacent to each other in the Y-axis direction, and spacers 250 respectively disposed on outer sides of the energy storage devices 100 at both ends in the Y-axis direction. The spacer 200 is also called, for example, an “inter-cell spacer”. The spacer 250 is also called, for example, an “end spacer”. In the present example embodiment, the spacers 200 and 250 also function as cell holders that hold one or more energy storage devices 100 disposed along the spacer 200 or 250. The spacer 200 according to the present example embodiment includes a first facing portion 210 (see FIG. 3). The first facing portion 210 functions as a portion that guides the bus bar 300 to an appropriate position. The configuration of the bus bar 300 and its periphery will be described later with reference to FIGS. 4 to 7.

The energy storage apparatus 10 has a substantially rectangular parallelepiped shape elongated in the Y-axis direction with the plurality of energy storage devices 100, the plurality of spacers 200, and the pair of spacers 250 arranged in the Y-axis direction. The plurality of energy storage devices 100 included in the energy storage apparatus 10 are electrically connected to each other by a plurality of the bus bars 300.

In the present example embodiment, the energy storage apparatus 10 is a non-binding type module that does not include a binding member (end plate, side plate, and the like) that binds the plurality of energy storage devices 100 in the Y-axis direction. However, the energy storage apparatus 10 may include a binding member that binds the plurality of energy storage devices 100 and the plurality of spacers 200 and 250 in the Y-axis direction.

The energy storage device 100 is a secondary battery (battery cell), more specifically a nonaqueous electrolyte secondary battery such as a lithium ion secondary battery. As illustrated in FIG. 3, the energy storage device 100 includes a container 110 having a flat rectangular parallelepiped shape (prismatic shape). An electrode assembly, a current collector, an electrolyte solution, and the like (not illustrated) are accommodated in the container 110. As the electrode assembly, for example, a winding-type electrode assembly formed by winding a plate and a separator is employed. As the electrode assembly, a layered (stacked) electrode assembly formed by layering a plurality of flat-shaped plates, or an electrode assembly having a structure in which long belt-shaped plates are layered in a bellows shape by repeating mountain folding and valley folding may be adopted. As the electrolyte solution to be accommodated in the container 110, a kind of the electrolyte solution is not particularly limited as long as performance of the energy storage device 100 is not impaired, and various electrolyte solutions can be selected. The energy storage device 100 may be a secondary battery other than the nonaqueous electrolyte secondary battery, or may be a capacitor. The energy storage device 100 may be a primary battery. The energy storage device 100 may be a battery using a solid electrolyte. The energy storage device 100 may be a pouch type energy storage device. The shape of the energy storage device 100 is not limited to the above prismatic shape, and may be a polygonal columnar shape, a cylindrical shape, an elliptical columnar shape, an oval columnar shape or the like other than the above prismatic shape.

As illustrated in FIG. 3, the container 110 is a rectangular parallelepiped case including a pair of long side surfaces 111, a pair of short side surfaces 112, and a bottom surface 113, which are formed of the container body, and a terminal arrangement surface 130 formed of a lid plate. After the electrode assembly and the like are accommodated in the inside of the container body, the inside of the container 110 is sealed by welding or the like between the container body and the lid plate. The material of the container 110 is not particularly limited, but is preferably weldable metal such as stainless steel, aluminum, an aluminum alloy, iron, or a plated steel plate.

The energy storage device 100 includes a terminal 140 arranged in the Z-axis direction. The Z-axis direction is an example of a second direction. The terminal 140 is electrically connected to the electrode assembly accommodated in the container 110. More specifically, a pair of the terminals 140 is disposed so as to project in the Z-axis positive direction from the terminal arrangement surface 130 of the container 110. The terminal arrangement surface 130 is further provided with a gas release valve 131. One of the pair of terminals 140 is electrically connected to a positive electrode of the electrode assembly, and the other is electrically connected to a negative electrode of the electrode assembly. Hereinafter, when the terminal 140 of the negative electrode and the terminal 140 of the positive electrode are distinguished from each other, the terminal 140 of the negative electrode is referred to as a negative electrode terminal 141, and the terminal 140 of the positive electrode is referred to as a positive electrode terminal 142.

The negative electrode terminal 141 includes a terminal body 141a made of aluminum or an aluminum alloy, and a shaft body made of copper or a copper alloy. The shaft body is joined to the terminal body 141a in a state of penetrating the terminal body 141a, and an end of the shaft body slightly projects from an upper surface (surface facing in the Z-axis positive direction, the same applies hereinafter) of the terminal body 141a. Thus, the terminal body 141a is formed with a terminal convex portion 141b formed of the end. The positive electrode terminal 142 is made of aluminum or an aluminum alloy, and has a flat upper surface.

In the present example embodiment, as illustrated in FIG. 3, the terminal 140 included in the first energy storage device 100A is referred to as a first terminal 140A, and the terminal 140 included in the second energy storage device 100B is referred to as a second terminal 140B. That is, the first energy storage device 100A includes the negative electrode terminal 141 and the positive electrode terminal 142, which are two first terminals 140A, and the second energy storage device 100B includes the negative electrode terminal 141 and the positive electrode terminal 142, which are two second terminals 140B. When the first energy storage device 100A and the second energy storage device 100B are arranged in the Y-axis direction, the first terminal 140A and the second terminal 140B are arranged in the Y-axis direction. In this state, one of the first terminal 140A and the second terminal 140B is the negative electrode terminal 141, and the other is the positive electrode terminal 142. FIG. 3 illustrates that the negative electrode terminal 141, which is the first terminal 140A, and the positive electrode terminal 142, which is the second terminal 140B, are connected by the bus bar 300.

As illustrated in FIG. 3, the bus bar 300 electrically and mechanically connecting the first terminal 140A and the second terminal 140B includes a first terminal connecting portion 310, a second terminal connecting portion 320, and an intermediate connecting portion 350. Each of the first terminal connecting portion 310 and the second terminal connecting portion 320 is a plate-shaped portion joined to the upper surface of the terminal 140. More specifically, the first terminal connecting portion 310 includes a first joining plate portion 311 and a second joining plate portion 312 each joined to the terminal 140. As illustrated in FIG. 3, the first joining plate portion 311 and the second joining plate portion 312 are disposed separately in the X-axis direction. The terminal convex portion 141b of the first terminal 140A is between the first joining plate portion 311 and the second joining plate portion 312. A method for joining each of the first terminal connecting portion 310 and the second terminal connecting portion 320 to the terminal 140 is not particularly limited, but for example, laser welding is used.

The intermediate connecting portion 350 is a plate-shaped portion that electrically and mechanically connects the first terminal connecting portion 310 and the second terminal connecting portion 320. In the present example embodiment, the intermediate connecting portion 350, the first terminal connecting portion 310, and the second terminal connecting portion 320 are integrally provided. More specifically, the first terminal connecting portion 310 is disposed on one side (the Y-axis negative direction in the present example embodiment) of the second terminal connecting portion 320 in the Y-axis direction. The intermediate connecting portion 350 is connected to an end of the first terminal connecting portion 310 on the other side in the Y-axis direction (an end in the Y-axis positive direction in the present example embodiment). Further, the intermediate connecting portion 350 is connected to an end of the second terminal connecting portion 320 on the other side. That is, the intermediate connecting portion 350 connects the end of the first terminal connecting portion 310 in the Y-axis positive direction and the end of the second terminal connecting portion 320 in the Y-axis positive direction.

The bus bar 300 illustrated in FIG. 3 and the like is an example of a bus bar that electrically and mechanically connects two energy storage devices 100 adjacent to each other in the Y-axis direction. That is, the configuration of the bus bar that electrically and mechanically connects the two energy storage devices 100 may be different from the configuration of the bus bar 300 illustrated in FIG. 3 and the like. For example, the two energy storage devices 100 may be electrically and mechanically connected to each other by a bus bar having a flat plate shape as a whole.

The case 600 is a container having a substantially rectangular parallelepiped shape (box shape) and accommodating the energy storage apparatus 10. The rectangular parallelepiped referred to herein is a hexahedron in which all surfaces are rectangular or square. The case 600 is disposed outward the energy storage apparatus 10 and protects the energy storage apparatus 10 from an impact or the like. The case 600 is formed of a metal member such as aluminum, an aluminum alloy, stainless steel, iron, or a plated steel plate. In the present example embodiment, the case 600 is formed by die-casting aluminum (aluminum die-casting). Instead of the case 600, a case formed of an insulating member such as a resin material may be adopted as a case for accommodating the energy storage apparatus 10.

As illustrated in FIG. 1, the case 600 includes the case body 610. The case body 610 is a housing in which an opening 610a of a size into which the energy storage apparatus 10 can be inserted is formed in the Z-axis positive direction. The case body 610 includes a case side wall portion 611 facing the energy storage apparatus 10 in the X-axis direction, a case side wall portion 612 facing the energy storage apparatus 10 in the Y-axis direction, and a case bottom wall portion 615 that supports the energy storage apparatus 10 from the Z-axis negative direction. The X-axis direction is an example of a third direction. The case 600 may further include a lid (not illustrated) that closes the opening 610a of the case body 610.

The bus bar assembly 400 includes the plurality of bus bars 300, the bus bar holder 401 that holds the plurality of bus bars 300, and a wiring board 500. The bus bar assembly 400 is disposed to face the energy storage apparatus 10 in the Z-axis direction. The bus bar holder 401 is a member formed of an insulating material such as resin, and includes a plurality of bus bar accommodating portions 405 that accommodates the plurality of bus bars 300. The bus bar accommodating portion 405 is a portion formed in a box shape, and accommodates and holds the bus bar 300 in a state where a lower surface (surface in the Z-axis negative direction) of the bus bar 300 is exposed. In the present example embodiment, as illustrated in FIGS. 1 and 2, the two energy storage devices 100 adjacent to each other in the Y-axis direction are connected in series by the bus bar 300. That is, the plurality of energy storage devices 100 included in the energy storage apparatus 10 are connected in series by the plurality of bus bars 300. Each of the plurality of bus bars 300 is held in the bus bar accommodating portion 405 at a position corresponding to the bus bar 300. In the present example embodiment, a bus bar 382 is joined to the negative electrode terminal 141 of the energy storage device 100 at the end of the energy storage apparatus 10 in the Y-axis positive direction, and a bus bar 381 is joined to the positive electrode terminal 142 of the energy storage device 100 at the end of the energy storage apparatus 10 in the Y-axis negative direction. The bus bars 382 and 381 are also held by the bus bar holder 401.

As illustrated in FIG. 2, the bus bar 382 is provided with a negative electrode total terminal 392 projecting in the Z-axis positive direction, and the bus bar 381 is provided with a positive electrode total terminal 391 projecting in the Z-axis positive direction. The negative electrode total terminal 392 and the positive electrode total terminal 391 are connected to another device by a cable or the like, whereby the energy storage apparatus 1 supplies power to the device. In place of or in addition to the power supply to the device, the energy storage apparatus 1 may be charged with power supplied from the device. Each of the negative electrode total terminal 392 and the positive electrode total terminal 391 may be used as an external terminal by projecting from the inside of the case 600 to the outside.

As illustrated in FIG. 2, the bus bar holder 401 includes, at a central portion in the X-axis direction, a board support portion 490 that supports the wiring board 500. The wiring board 500 supported by the board support portion 490 includes a board formed of an insulating material and wiring of a conductor formed on the board. A plurality of conductive members 590 is connected to the wiring board 500, and each of the plurality of conductive members 590 is connected to one bus bar 300, 381, or 382. A connector 510 is connected to an end of the wiring board 500 in the Y-axis positive direction. For example, a control device that controls charge-discharge of the energy storage apparatus 1 is connected to the connector 510. The control device detects a voltage of each of the plurality of energy storage devices 100 via the plurality of conductive members 590 and the wiring board 500, and controls charge-discharge of the plurality of energy storage devices 100 based on a detection result. That is, in the present example embodiment, the conductive member 590 is a terminal (detection terminal) for voltage detection.

Next, the configuration of the bus bar 300 and its periphery will be described with reference to FIGS. 4 to 7 in addition to FIGS. 1 to 3 described above. Hereinafter, with attention being paid to one bus bar 300 that electrically connects two energy storage devices 100 (the first energy storage device 100A and the second energy storage device 100B) adjacent to each other, the configuration of the bus bar 300 and its periphery will be described.

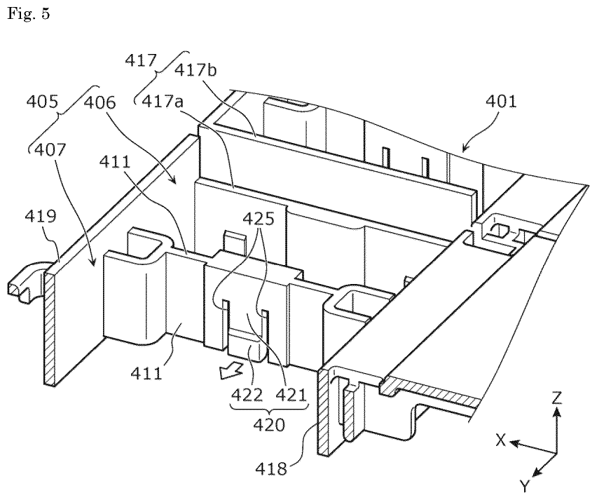

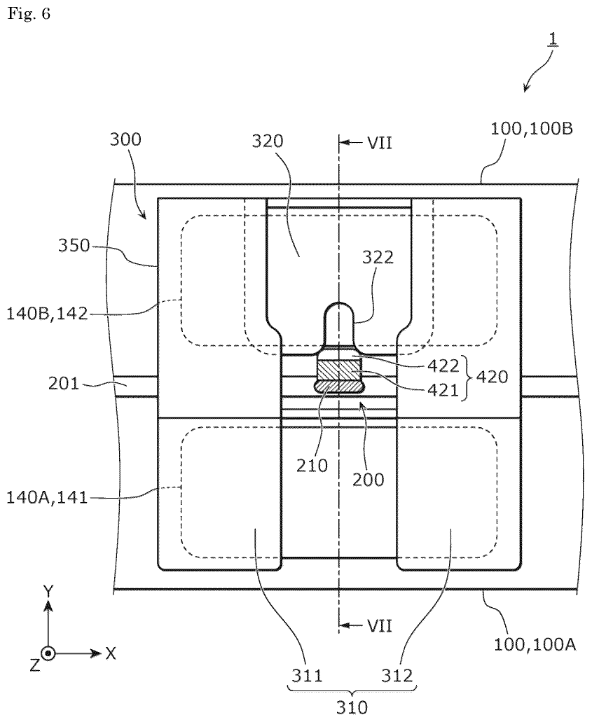

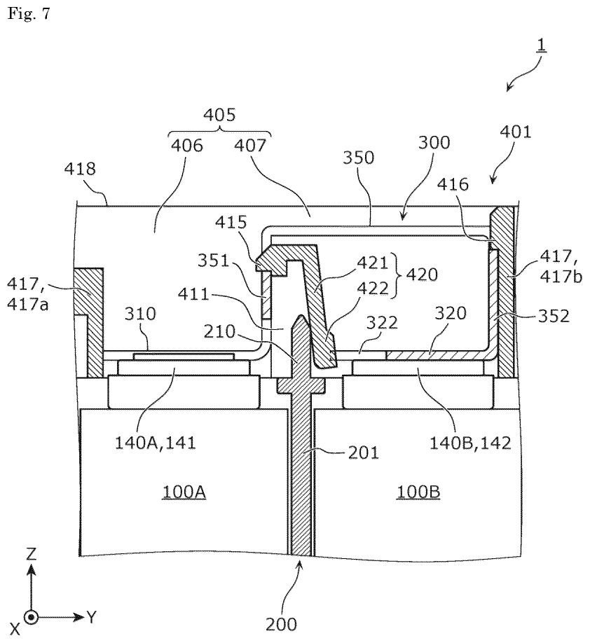

FIG. 4 is an enlarged perspective view illustrating the configuration of the bus bar 300 and its periphery according to the present example embodiment. In FIG. 4, the bus bar holder 401 is illustrated separated in the Z-axis positive direction from the two energy storage devices 100, and the bus bar 300 is illustrated separated in the Z-axis positive direction from the bus bar holder 401. In FIG. 4, in order to clearly illustrate the configuration of the bus bar accommodating portion 405, the bus bar holder 401 is illustrated in a state of being cut at a position in front of the bus bar 300 (in the Y-axis negative direction). FIG. 5 is a perspective view illustrating the configuration of the bus bar accommodating portion 405 according to the present example embodiment. FIG. 5 illustrates the bus bar accommodating portion 405 when the bus bar accommodating portion 405 is viewed obliquely rearward (when the Y-axis positive direction is defined as rearward). In FIG. 5, in order to clearly illustrate the configuration of the bus bar accommodating portion 405, the bus bar holder 401 is illustrated in a state of being cut at a position behind an intermediate wall portion 411 (in the Y-axis positive direction). FIG. 6 is a plan view (as viewed in the Z-axis positive direction) illustrating a positional relationship among the first facing portion 210, a second facing portion 420, and the bus bar 300 according to the present example embodiment. FIG. 7 is a cross-sectional view illustrating the positional relationship among the first facing portion 210, the second facing portion 420, and the bus bar 300 according to the present example embodiment. FIG. 7 simply illustrates a cross section taken along line VII-VII in FIG. 6. FIG. 7 simply illustrates not a cross section but side surfaces of the two energy storage devices 100.

As illustrated in FIGS. 4 to 7, the bus bar holder 401 includes the bus bar accommodating portion 405 that accommodates the bus bar 300. The bus bar 300 accommodated in the bus bar accommodating portion 405 is positioned between a pair of side wall portions 417 facing each other in the Y-axis direction. In the present example embodiment, the side wall portion 417 includes a first side wall portion 417a (see FIG. 5) and a second side wall portion 417b (see FIG. 4). The first side wall portion 417a is arranged in the Y-axis negative direction of the bus bar 300 illustrated in FIG. 4, and the second side wall portion 417b is arranged in the Y-axis positive direction of the bus bar 300. That is, in the present example embodiment, the two bus bar accommodating portions 405 adjacent to each other in the Y-axis direction are partitioned by the two wall portions (first side wall portion 417a and second side wall portion 417b) adjacent to each other in the Y-axis direction. This is not essential, and the two bus bar accommodating portions 405 adjacent to each other in the Y-axis direction may be partitioned by a single wall portion.

The bus bar 300 accommodated in the bus bar accommodating portion 405 is positioned between an outer wall portion 419 positioned in the X-axis positive direction and an inner wall portion 418 positioned in the X-axis negative direction. That is, in the present example embodiment, the bus bar accommodating portion 405 is configured such that the bus bar 300 accommodated in the bus bar accommodating portion 405 is surrounded by the pair of side wall portions 417, the inner wall portion 418, and the outer wall portion 419.

More specifically, the bus bar accommodating portion 405 includes a first accommodating portion 406 that accommodates the first terminal connecting portion 310 of the bus bar 300 and a second accommodating portion 407 that accommodates the second terminal connecting portion 320 of the bus bar 300. The first accommodating portion 406 and the second accommodating portion 407 are partitioned by the intermediate wall portion 411. The intermediate wall portion 411 includes the second facing portion 420. The second facing portion 420 is a portion of the intermediate wall portion 411, and is a portion between a pair of slits 425 extending from an end edge (end edge in the Z-axis negative direction in the present example embodiment) of the intermediate wall portion 411. That is, one end (end in the Z-axis positive direction in the present example embodiment) of the second facing portion 420 is fixed to the intermediate wall portion 411. The other end (end in the Z-axis negative direction in the present example embodiment) of the second facing portion 420 is not fixed to the intermediate wall portion 411. Therefore, the second facing portion 420 is easily deformed so as to warp in the Y-axis direction.

The spacer 200 facing the bus bar holder 401 in the Z-axis direction and disposed side by side with the energy storage device 100 in the Y-axis direction includes the first facing portion 210. Specifically, the spacer 200 includes a spacer body portion 201 facing the energy storage device 100 in the Y-axis direction, and the first facing portion 210 projecting in the Z-axis positive direction from the spacer body portion 201. In the present example embodiment, the spacer 200 further includes a spacer bottom wall portion 203 facing the bottom surface 113 of the energy storage device 100, and a pair of spacer side wall portions 202 facing the pair of short side surfaces 112 of the energy storage device 100. The spacer 200 includes the spacer bottom wall portion 203, the pair of spacer side wall portions 202, and the like, so that the spacer 200 also functions as a cell holder that holds the energy storage device 100. The spacer 200 further includes a protrusion 230 to be inserted into an attachment portion 430 of the bus bar holder 401. The protrusion 230 is provided so as to project from the spacer body portion 201 in the Z-axis positive direction. The bus bar holder 401 is attached to the energy storage apparatus 10 by inserting the protrusion 230 of each of the plurality of spacers 200 into the attachment portion 430 disposed at a position corresponding to the protrusion 230. In this state, the movement of the bus bar holder 401 as a whole with respect to the energy storage apparatus 10, that is, the movement parallel to an XY plane and the movement in the Z-axis direction are restricted.

When the bus bar holder 401 is attached to the energy storage apparatus 10 as described above, the first facing portion 210 faces, in the Y-axis direction, the second facing portion 420 included in the bus bar holder 401 (see FIGS. 6 and 7). Specifically, the movement of the bus bar holder 401 with respect to the spacer 200 in the Y-axis direction is restricted by, for example, the protrusion 230 of the spacer 200 inserted into the attachment portion 430 of the bus bar holder 401. In this state, as illustrated in FIGS. 6 and 7, the first facing portion 210 of the spacer 200 is positioned in the Y-axis negative direction of the second facing portion 420 of the bus bar holder 401 and is in contact with the second facing portion 420. As a result, for example as illustrated in FIG. 7, the second facing portion 420 is deformed so as to warp in the Y-axis positive direction, and is brought into contact with a portion of the bus bar 300. Accordingly, the bus bar 300 is guided to a predetermined position in the Y-axis direction. That is, the bus bar 300 is guided by the first facing portion 210 and the second facing portion 420 to a predetermined position based on the spacer 200 (see FIGS. 6 and 7) positioned between the first energy storage device 100A and the second energy storage device 100B. Thus, the bus bar 300 is guided to a position suitable for joining to each of the first terminal 140A and the second terminal 140B. In a state where the bus bar 300 is guided to the position suitable for the joining, the bus bar 300 is joined to the first terminal 140A and the second terminal 140B by laser welding or the like. Thus, the bus bar 300 is accurately joined to the terminal 140 of the energy storage device 100.

More specifically, as illustrated in FIG. 4, the intermediate connecting portion 350 of the bus bar 300 includes a first intermediate portion 351, a second intermediate portion 352, and a third intermediate portion 355. The first intermediate portion 351 is connected to the first terminal connecting portion 310 and extends in the Z-axis direction. The second intermediate portion 352 is connected to the second terminal connecting portion 320 and extends in the Z-axis direction. The third intermediate portion 355 connects the first intermediate portion 351 and the second intermediate portion 352.

When the bus bar 300 configured as described above is guided to the position suitable for joining to the terminal 140 as described above, the second intermediate portion 352 of the bus bar 300 is disposed close to or in contact with the second side wall portion 417b (see FIG. 7). At this time, the first intermediate portion 351 of the bus bar 300 is disposed close to or in contact with the intermediate wall portion 411 (see FIG. 7). That is, in the present example embodiment, the movement of the bus bar 300 in the Y-axis positive direction is restricted by at least one of the second side wall portion 417b and the intermediate wall portion 411 included in the bus bar holder 401. Further, in this state, the movement of the bus bar 300 in the Z-axis positive direction is also restricted.

Specifically, the bus bar holder 401 includes: a first projecting portion 415 provided on the intermediate wall portion 411 and projecting in the Y-axis negative direction; and a second projecting portion 416 provided on the side wall portion 417 (second side wall portion 417b) and projecting in the Y-axis negative direction (see FIGS. 4 and 7). As illustrated in FIGS. 6 and 7, in a state where the bus bar 300 is guided to an appropriate position in the Y-axis direction, each of the first projecting portion 415 and the second projecting portion 416 faces the bus bar 300 in the Z-axis direction. Specifically, the first projecting portion 415 faces the first intermediate portion 351 of the bus bar 300 in the Z-axis direction, and the second projecting portion 416 faces the second intermediate portion 352 of the bus bar 300 in the Z-axis direction. Thus, the movement of the bus bar 300 in the Z-axis positive direction is restricted. In other words, the movement of the bus bar 300 in the Y-axis negative direction is restricted by the first facing portion 210 (via the second facing portion 420). Therefore, it is difficult to perform movement (that is, movement in the Y-axis negative direction) for avoiding interference with the first projecting portion 415 and the second projecting portion 416, which is necessary when the bus bar 300 moves in the Z-axis positive direction. Thus, the movement of the bus bar 300 in the Z-axis positive direction is restricted. As a result, the bus bar 300 is more accurately joined to the terminal 140 of the energy storage device 100.

As described above, the energy storage apparatus 1 according to the present example embodiment includes the first energy storage device 100A, the spacer 200, the bus bar 300, and the bus bar holder 401. The first energy storage device 100A and the spacer 200 are arranged side by side in the Y-axis direction. The first energy storage device 100A includes the first terminal 140A arranged in the Z-axis direction intersecting the Y-axis direction. The bus bar 300 is joined to the first terminal 140A. The spacer 200 includes the first facing portion 210. The bus bar holder 401 includes the second facing portion 420 facing the first facing portion 210 in the Y-axis direction. The second facing portion 420 is between the first facing portion 210 and a portion of the bus bar 300 in the Y-axis direction.

According to this configuration, the first facing portion 210 of the spacer 200 faces the second facing portion 420 of the bus bar holder 401 in the arranging direction (Y-axis direction) of the first energy storage device 100A and the spacer 200. Further, the second facing portion 420 is between the first facing portion 210 and a portion of the bus bar 300. Specifically, in the present example embodiment, the second facing portion 420 is between the second terminal connecting portion 320 (see FIGS. 4 and 6), which is a portion of the bus bar 300, and the first facing portion 210. Therefore, the first facing portion 210 of the spacer 200 can restrict the movement of the bus bar 300 in the Y-axis direction (movement in the Y-axis negative direction in the present example embodiment) via the second facing portion 420. Accordingly, the first facing portion 210 of the spacer 200 can guide the bus bar 300 to the position suitable for joining the bus bar 300 and the first terminal 140A. As a result, the bus bar 300 can be accurately joined to the first terminal 140A. Accordingly, the energy storage apparatus 1 according to the aspect is an energy storage apparatus with improved reliability.

More specifically, the spacer 200 including the first facing portion 210 guiding the arrangement position of the bus bar 300 is arranged in contact with the first energy storage device 100A. Thus, it is possible to more reliably guide the bus bar 300 to the position suitable for joining the bus bar to the first terminal 140A of the first energy storage device 100A.

In the energy storage apparatus 1 according to the present example embodiment, the first facing portion 210 is in contact with the second facing portion 420 in the Y-axis direction. In the bus bar holder 401, the end (end in the Z-axis positive direction in the present example embodiment) of the second facing portion 420 on one side in one direction intersecting the Y-axis direction is fixed, and the end (end in the Z-axis negative direction in the present example embodiment) on the other side in the one direction is not fixed.

As described above, in the present example embodiment, the second facing portion 420 includes a fixed end fixed to a portion other than the second facing portion 420 of the bus bar holder 401 and a free end opposite to the fixed end. Accordingly, the second facing portion 420 is brought into contact with the first facing portion 210 in the Y-axis direction, so that the second facing portion can be efficiently displaced or deformed in a direction toward the portion of the bus bar 300. As a result, the second facing portion 420 can efficiently guide the bus bar 300 to an appropriate position.

In the energy storage apparatus 1 according to the present example embodiment, the bus bar holder 401 includes the intermediate wall portion 411 positioned between the first facing portion 210 and a portion of the bus bar 300 in the Y-axis direction. The second facing portion 420 is a portion of the intermediate wall portion 411.

As described above, since the second facing portion 420 is provided as a portion of the intermediate wall portion 411, the mechanical strength of the second facing portion 420 is improved. Accordingly, for example, the second facing portion 420 can be deformed more greatly as necessary. Thus, it is easy to expand an arrangeable range (range in the Y-axis direction) of the bus bar 300 to which the bus bar can be guided by the first facing portion 210 and the second facing portion 420.

More specifically, the energy storage apparatus 1 further includes the second energy storage device 100B (see FIGS. 3 and 4). The second energy storage device 100B includes the second terminal 140B arranged in the Z-axis direction. The spacer 200 is positioned between the first energy storage device 100A and the second energy storage device 100B in the Y-axis direction. The bus bar 300 is joined to the first terminal 140A and the second terminal 140B.

As described above, when attention is paid to the two energy storage devices 100 adjacent to each other in the Y-axis direction with the spacer 200 interposed therebetween, the bus bar 300 for connecting the two energy storage devices 100 is restricted in movement by the first facing portion 210 of the spacer 200. Thus, the bus bar 300 is disposed at the position suitable for joining to the respective terminals 140 of the two energy storage devices 100.

In the energy storage apparatus 1 according to the present example embodiment, the first facing portion 210 is arranged side by side with the first terminal 140A in the Y-axis direction. That is, when viewed in the Y-axis direction, at least a portion of the first facing portion 210 overlaps the first terminal 140A. More preferably, the entire area of the first facing portion 210 in the X-axis direction overlaps the first terminal 140A when viewed in the Y-axis direction.

According to this configuration, the first facing portion 210 is arranged in the range of the width of the first terminal 140A in the X-axis direction intersecting the Y-axis direction and the Z-axis direction. Accordingly, the bus bar holder 401 can be provided with the second facing portion 420 without increasing the width of the bus bar holder 401 in the X-axis direction.

In the energy storage apparatus 1 according to the present example embodiment, the second facing portion 420 includes a convex portion 422 projecting toward a portion of the bus bar 300 as illustrated in FIGS. 5 to 7. As illustrated in FIGS. 6 and 7, the bus bar 300 includes a recessed portion 322 into which at least a portion of the convex portion 422 is inserted. In the present example embodiment, the second facing portion 420 includes a facing body portion 421 extending in the Z-axis direction and the convex portion 422 provided at an end of the facing body portion 421 in the Z-axis negative direction. The bus bar 300 includes the recessed portion 322 recessed in the Y-axis positive direction at an end of the second terminal connecting portion 320 in the Y-axis negative direction (see FIG. 6).

According to this configuration, at least a portion of the convex portion 422 of the second facing portion 420 is inserted into the recessed portion 322 of the bus bar 300 in the Y-axis direction. Thus, the movement of the bus bar 300 in the X-axis direction intersecting the Y-axis direction and the Z-axis direction is restricted. That is, the first facing portion 210 can also restrict the movement of the bus bar 300 in the X-axis direction via the second facing portion 420. As a result, the bus bar 300 is more reliably guided to an appropriate position.

Although the energy storage apparatuses 1 according to example embodiments of the present invention have been described above, the present invention is not limited to the above example embodiments. The example embodiments disclosed herein are examples in all respects, and the scope of the present invention includes all changes within the meaning and scope equivalent to the claims.

In the above example embodiments, as illustrated in FIG. 1, the spacer 200 is disposed at all times between two energy storage devices 100 adjacent to each other in the energy storage apparatus 10. However, this is not essential. For example, when two or more energy storage devices 100 among the plurality of energy storage devices 100 included in the energy storage apparatus 10 are connected in parallel, the spacer 200 may not be disposed between two energy storage devices 100 adjacent to each other in the two or more energy storage devices 100. That is, when the two or more energy storage devices 100 connected in parallel are regarded as an energy storage device 100 group, the spacer 200 may be disposed only between two energy storage device 100 groups adjacent to each other. Even in this case, the bus bar 300 positioned at a position overlapping the spacer 200 in plan view can be guided to an appropriate position by the first facing portion 210 of the spacer 200 and the second facing portion 420 of the bus bar holder 401.

The first facing portion 210 of the spacer 200 does not necessarily project from the spacer body portion 201 in the Z-axis positive direction. For example, a portion of an end of the spacer body portion 201 in the Z-axis positive direction may function as the first facing portion 210. That is, in the spacer 200, the first facing portion 210 does not need to be provided in a manner clearly distinguishable from portions other than the first facing portion 210.

The second facing portion 420 of the bus bar holder 401 may not include the convex portion 422 (see FIGS. 5 to 7). The shape and size of the second facing portion 420 are not particularly limited as long as the second facing portion 420 is configured to be deformed in the Y-axis direction by receiving force from the first facing portion 210.

The bus bar 300 may not include the recessed portion 322 (see FIGS. 6 and 7). For example, an end edge of the second terminal connecting portion 320 (see FIG. 4) in the Y-axis negative direction may have a linear shape parallel to the X-axis direction in plan view. The end edge may have a shape projecting in the Y-axis negative direction in plan view. In either case, the bus bar 300 is guided to an appropriate position by the contact between the end edge and the second facing portion 420.

The second facing portion 420 of the bus bar holder 401 may be arranged in the Y-axis negative direction of the first facing portion 210 of the spacer 200. In this case, the second facing portion 420 may be in contact with an end (or the end of the first terminal connecting portion 310 in the Y-axis positive direction) of the first intermediate portion 351 of the bus bar 300 in the Z-axis negative direction. That is, the positional relationship among the first facing portion 210, the second facing portion 420, and a portion of the bus bar 300 (a portion facing the second facing portion 420) in the Y-axis direction may be opposite to the positional relationship illustrated in FIG. 7. Even in this case, the bus bar 300 is guided to a predetermined position based on the spacer 200. That is, the first facing portion 210 can guide the bus bar 300 to a position suitable for joining to the terminals 140 of one or more energy storage devices 100 via the second facing portion 420.

The second facing portion 420 of the bus bar holder 401 may be fixed, not at one end in the Z-axis direction but at one end in the X-axis direction, to the intermediate wall portion 411. Even in this case, the second facing portion 420 can be deformed so as to warp in the Y-axis positive direction by coming into contact with the first facing portion 210 positioned in the Y-axis negative direction. Thus, the first facing portion 210 can guide the bus bar 300 to an appropriate position via the second facing portion 420.

The bus bar holder 401 is attached to the energy storage apparatus 10 by inserting the protrusion 230 of the spacer 200 into the attachment portion 430 of the bus bar holder 401. However, a method of attaching the bus bar holder 401 to the energy storage apparatus 10 is not particularly limited. For example, the bus bar holder 401 may be attached to the energy storage apparatus 10 by fixing the bus bar holder 401 to the case body 610 (see FIG. 1) by adhesion, welding, fitting, joining with a bolt, or the like. Even in this case, the bus bar 300 is guided to a predetermined position based on the spacer 200 arranged side by side with the energy storage device 100 in the Y-axis direction. That is, the bus bar 300 is guided to a position suitable for joining to the terminal 140 of the energy storage device 100.

The configuration of the bus bar accommodating portion 405 may be different from the configurations illustrated in FIGS. 2, 4, 5, 7, and the like. For example, the bus bar accommodating portion 405 may not cover the entire circumference of the bus bar 300 in plan view. That is, the bus bar accommodating portion 405 may not include at least one wall portion of the pair of side wall portions 417, the inner wall portion 418, and the outer wall portion 419. However, for example, from the viewpoint of improving the reliability of insulation between the bus bar 300 and other members (or humans), the bus bar accommodating portion 405 is preferably configured to cover the entire circumference of the bus bar 300 in plan view.

The bus bar accommodating portion 405 may not include the intermediate wall portion 411. Even when the bus bar accommodating portion 405 does not include the intermediate wall portion 411, the bus bar holder 401 includes a portion that supports the second facing portion 420, so that the first facing portion 210 can guide the bus bar 300 to an appropriate position via the second facing portion 420.

The bus bar assembly 400 may not include the wiring board 500. For example, a sheathed cable for voltage detection may be electrically connected to each of the plurality of bus bars 300. That is, the voltages of the plurality of energy storage devices 100 may be detected via a plurality of sheathed cables.

The energy storage apparatus 1 may not include the case 600. For example, a structure including the energy storage device 100, the spacer 200, the bus bar 300, and the bus bar holder 401 may be accommodated as the energy storage apparatus 1 in any device, a rack, or the like.

Example embodiments constructed by arbitrarily combining the components, features, etc., included in the above example embodiments and the modification examples thereof are also included in the scope of the present invention.

Example embodiments of the present invention can be applied to energy storage apparatuses or the like including an energy storage device such as a lithium ion secondary battery.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An energy storage apparatus comprising:
a first energy storage device;
a spacer;
a bus bar; and
a bus bar holder; wherein
the first energy storage device and the spacer are arranged side by side in a first direction;
the first energy storage device includes a first terminal arranged in a second direction intersecting the first direction;
the bus bar is joined to the first terminal;
the spacer includes a first facing portion;
the bus bar holder includes a second facing portion facing the first facing portion in the first direction; and
the second facing portion is between the first facing portion and a portion of the bus bar in the first direction.

2. The energy storage apparatus according to claim 1, wherein
the first facing portion is in contact with the second facing portion in the first direction; and
an end of the second facing portion on one side in one direction intersecting the first direction is fixed and an end of the second facing portion on the other side in the one direction is not fixed in the bus bar holder.

3. The energy storage apparatus according to claim 2, wherein
the bus bar holder includes an intermediate wall portion positioned between the first facing portion and the portion of the bus bar in the first direction; and
the second facing portion is a portion of the intermediate wall portion.

4. The energy storage apparatus according to claim 1, further comprising:
a second energy storage device; wherein
the second energy storage device includes a second terminal arranged in the second direction;
the spacer is positioned between the first energy storage device and the second energy storage device in the first direction; and
the bus bar is joined to the first terminal and the second terminal.

5. The energy storage apparatus according to claim 1, wherein the first facing portion is arranged side by side with the first terminal in the first direction.

6. The energy storage apparatus according to claim 1, wherein
the second facing portion includes a convex portion projecting toward the portion of the bus bar; and
the bus bar includes a recessed portion into which at least a portion of the convex portion is inserted.
